(19) United States
(12) Patent Application Publication
(10) Pub. No.: US 2024/0161019 A1
(43) Pub. Date: May 16, 2024

(54) METHOD AND DEVICE FOR DETERMINING SIMILARITY OF PROGRAMMING CODES BASED ON CROSS-VALIDATION ENSEMBLE AND FILTERING STRATEGY

(71) Applicant: KOREA UNIVERSITY RESEARCH AND BUSINESS FOUNDATION, Seoul (KR)

(72) Inventors: Heuiseok LIM, Suwon-si (KR); Gyeongmin KIM, Seoul (KR)

(73) Assignee: KOREA UNIVERSITY RESEARCH AND BUSINESS FOUNDATION, Seoul (KR)

(21) Appl. No.: 18/507,705

(22) Filed: Nov. 13, 2023

(30) Foreign Application Priority Data
Nov. 14, 2022 (KR) 10-2022-0151807

(51) Int. Cl. G06N 20/20; G06F 16/215; G06F 16/901

(52) U.S. Cl. CPC G06N 20/20; G06F 16/215; G06F 16/9014

(57) ABSTRACT

Disclosed herein is a method of generating a similarity determination model of programming codes based on a cross-validation ensemble and filtering strategy. The method of generating the similarity determination model is performed by a computing device including at least a processor, the method includes: performing preprocessing on raw data written in any one language; performing filtering on the preprocessed data; generating positive pairs and negative pairs for training; and training a pre-trained language model using the generated positive pairs and negative pairs.

### CROSS REFERENCE TO RELATED APPLICATION

The present application claims priority to Korean Patent Application No. 10-2022-0151807, filed on Nov. 14, 2022, the entire contents of which is incorporated herein for all purposes by this reference.

### BACKGROUND OF THE INVENTION

### Field of the Invention

The present invention relates to an artificial intelligence (AI) language model that is capable of comparing and determining a similarity between identical code languages in a program source code.

### Description of the Related Art

Pre-trained language models (PLMs) such as Bidirectional Encoder Representations from Transformers (BERT), Generative Pre-Training (GPT), and eXtra Long NETwork (XLNET) have led to tremendous performance enhancements in the field of natural language processing (NLP) in recent years, especially in downstream tasks such as machine reading comprehension (MRC), named entity recognition (NER), and relation extraction. These PLMs are based on a transformer architecture, in which the model is first pre-trained with a large unsupervised text corpus and then finetuned with training data on the downstream tasks. An approach of the pre-trained and fine-tuned model in the NLP has promoted the development of pre-training for programming languages.

CodeBERT and graphcodebert are language models that have learned both natural and programming languages, and are PLMs optimized for code, such as code search and code document generation. Both models were pretrained on the CodeSearchNet dataset, which includes functions from six programming languages along with natural language documents.

The CodeBERT was trained on objective functions including standard masked language modeling (MLM) and replaced token detection (RTD) in the pre-training process, while the graphcodebert was trained on code representations using the semantic structure of the code. These pre-trained models that have been learned the code representations are different and more general-purpose than general PLMs that have not learned code in that the models can classify the similarity thereof when inputting a programming language.

In recent years, there has been a severe shortage of software developers and experts around the world to supply quality software. In order to increase software productivity with a limited supply of software developers, it is essential to prepare a method of analyzing, developing, and maintaining software based on an automated method in advance, and many studies are being conducted in this field worldwide. To this end, as a first step, an algorithm that determines whether two codes can produce the same results is crucial to promote productivity.

The present invention proposes a language model, device, and system for determining the similarity of code in an automated method. A three-step strategic data filtering process for effective language model training can completely eliminate redundancy in training and testing, and positive pairs and negative pairs were generated with algorithms such as BM25 and BM25L of Okapi system with proven performance. In addition, a cross-validation ensemble method can extract accurate and effective performance in the model training process in which data imbalance exists.

### SUMMARY OF THE INVENTION

The technical objective achieved by the present invention is to provide a device for comparing and determining a similarity between the same code languages in various program source codes, and a method thereof.

A method of generating a similarity determination model, according to an embodiment of the present invention, is performed by a computing device including at least a processor, the method includes: performing preprocessing on raw data written in any one language; performing filtering on the preprocessed data; generating positive pairs and negative pairs for training; and training a pre-trained language model using the generated positive pairs and negative pairs.

According to embodiments of the present invention, it is possible to determine a similarity to eliminate redundancy in code in various programming languages such as Python, Java, C++, C, Ruby, C#, and the like.

In addition, the similarity between codes is assessed by units of sentences rather than by units of tokens, and high performance is achieved through cross-validation and data filtering.

### BRIEF DESCRIPTION OF THE DRAWINGS

Detailed description related to each drawing is provided to further sufficiently understand drawings cited in the detailed description of the present invention:

FIG. 1 illustrates an overall schematic view of the present invention.

FIG. 2 is a view for describing k-fold cross-validation.

FIG. 3 is a flowchart for describing a method of generating a similarity determination model according to an embodiment of the present invention.

### DETAILED DESCRIPTION OF THE INVENTION

Disclosed hereinafter are exemplary embodiments of the present invention. Particular structural or functional descriptions provided for the embodiments hereafter are intended merely to describe embodiments according to the concept of the present invention. The embodiments are not limited as to a particular embodiment.

Terms such as “first” and “second” may be used to describe various parts or elements, but the parts or elements should not be limited by the terms. The terms may be used to distinguish one element from another element. For instance, a first element may be designated as a second element, and vice versa, while not departing from the extent of rights according to the concepts of the present invention.

Unless otherwise clearly stated, when one element is described, for example, as being “connected” or “coupled” to another element, the elements should be construed as being directly or indirectly linked (i.e., there may be an intermediate element between the elements). Similar interpretation should apply to such relational terms as “between”, “neighboring,” and “adjacent to.”

Terms used herein are used to describe a particular exemplary embodiment and should not be intended to limit the present invention. Unless otherwise clearly stated, a singular term denotes and includes a plurality. Terms such as “including” and “having” also should not limit the present invention to the features, numbers, steps, operations, subparts and elements, and combinations thereof, as described; others may exist, be added or modified. Existence and addition as to one or more of features, numbers, steps, etc. should not be precluded.

Unless otherwise clearly stated, all of the terms used herein, including scientific or technical terms, have meanings which are ordinarily understood by a person skilled in the art. Terms, which are found and defined in an ordinary dictionary, should be interpreted in accordance with their usage in the art. Unless otherwise clearly defined herein, the terms are not interpreted in an ideal or overly formal manner.

Example embodiments of the present invention are described with reference to the accompanying drawings. However, the scope of the claims is not limited to or restricted by the example embodiments. Like reference numerals proposed in the respective drawings refer to like elements.

The present invention proposes a method of filtering a plurality of data to remove redundancy in a training dataset, and a method of obtaining positive pairs and negative pairs of data using a predetermined algorithm (BM25, BM25L, etc.).

In addition, for more effective performance, in the present invention, a language model (e.g., CodeBERT, graphcodebert, etc.) that is pre-trained on a code representation may be finetuned and a cross-validation ensemble may be applied during inference.

In addition, quantitative experimental results for single and ensemble models are derived to verify the effectiveness of the method proposed in the present invention.

In addition, the methods proposed by the present invention may be performed by a computing device including at least a processor and/or a memory. The computing device may include a personal computer (PC), a laptop computer, a tablet PC, a server, and the like, and thus the computing device may be referred to as a similarity determination device (of a programming code).

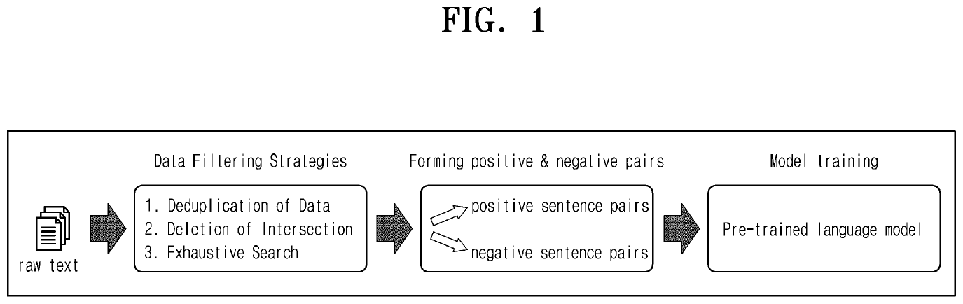

Hereinafter, a data preprocessing process, filtering strategies, a method of generating positive and negative pairs, and a cross-validation ensemble are described. FIG. 1 illustrates an overall schematic view of the present invention.

### Data Preprocessing

Due to the characteristic of the code, a cleaning operation may be performed before code data is fed into an input sequence of the model. This is because a source code may be written in an unorganized form, or the source code may include text information that is not relevant to an actual compilation.

Specifically, unnecessary new lines and/or spaces may be removed for each piece of data (source codes). For example, unnecessary new lines may mean new lines with no (substantive) content, and unnecessary spaces may mean a space positioned at the beginning of each line, a space positioned at the end of each line, at least one space other than any of the consecutive spaces, or the like. Comments that are included in the source code to assist developers and others in understanding (e.g., sequences marked with ‘#’) may also be removed, either in combination with null space or alone, as they are unnecessary information for a training process. That is, the data preprocessing process may be understood as an operation that includes removing at least one of a new line, a space, a comment, and a null space.

### Data Filtering

In the process of using different data as a single training and test data, redundancy (duplication) of data may occur, and the model trained with such data may not perform an accurate evaluation. Before enhancing the performance of the model with additional data, data redundancy between the additional (training) data and the test data was observed. Therefore, a filtering operation is performed over a plurality of steps (e.g., three steps). A three-step data filtering method is described in Algorithm 1.

[Algorithm 1]
Algorithm 1 Efficient Data Filtering Strategies

```
A = DATA1, B = DATA2
Load TEST_codes
  procedure DEDUPLICATION(sequence, HT)
  → Quick check if i is in HT
```

| | |
|---|---|
| 1: | Read All A, B values |
| 2: | for i = 0 to len(A[i]) do |
| 3: | HT.add(A[i]) |

→ Build HT

| | |
|---|---|
| 4: | for i = 0 to len(A[i]) do |
| 5: | if B[i] not in HT then |
| 6: | First_filtered_codes.append(B[i]) |

```
  → First Filtering
  procedure SIMPLIFY(code)
```

| | |
|---|---|
| 7: | return ‘’.join(code.split(‘\n’)).rstrip(‘ ’).strip( ) |

procedure DELETE INTERSECTION(First_filtered_codes)

| | |
|---|---|
| 8: | for i = 0 to len(First_filtered_codes[i]) do |
| 9: | if SIMPLIFY(First_filtered_codes[i]) not in |

INTERSECTION(TEST_codes) then

10:

```
Second_filtered_codes.append(First_filtered_codes[i])
  → Second Filtering
  procedure EXHAUSTIVE SEARCH(Second_filtered_codes)
```

| | |
|---|---|
| 11: | for i = 0 to len (Second_filtered_codes[i]) do |
| 12: | USE_TOKEN = True |
| 13: | if Second_filtered_codes[i] in TEST_codes then |
| 14: | continue |
| 15: | else |
| 16: | for s = 0 to TEST_codes do len(s) > 0 and |

len(Second_filtered_codes[i]) > and ((Second_filtered_codes[i]
in s)

| | |
|---|---|
| | or (s in Second_filtered_codes[i])) |
| 17: | USE_TOKEN = False |
| 18: | if USE_TOKEN == True then |
| 19: | |

Third_filtered_codes.append(Second_filtered_codes[i])
→ Third Filtering

| | |
|---|---|
| 20: | Return Third_filtered_codes |

### 1) Deduplication of Data

First, the data corresponding to A and B and the test data (TEST codes) are called. In this case, assuming that A and B are written in the same programming language, but represent different data, a hash table (HT) of A and/or B may be generated, and the hash table may be used to eliminate all duplicated data included in A and B.

According to an embodiment, a first filtering technique means a method of filtering overlapping sequence data using the hash table. This is a method of writing all values of A in the HT, and identifying whether these values exist in B. The HT may mean a set of information recorded in units of words of a source. In the first filtering (lines 1 to 6) of Algorithm 1, (1) the code sequence input to DEDUPLICATION function and the initialized HT generate a new HT from A. In addition, (2) first_filtered_codes is generated by comparing the newly generated HT to B (line 6). In this process, most redundancies are filtered out. That is, the first filtered code may mean A and B with duplicated content removed.

### 2) Deletion of Intersection

A second filtering aims to filter out data that was not fully filtered with the HT during the first filtering process for reasons such as trailing space. Unfiltered data may mean spaces such as white spaces (e.g., ‘’) and/or tabs (e.g., ‘\t’) at the left or right edge of sentences. In the second filtering of Algorithm 1 (lines 7 to 10), (1) SIMPLIFY function concatenates all the new lines that exist in code character strings. (2) All white spaces and new lines existing before and after the character strings are removed. (3) Filtering is performed once more by taking the intersection of these filtered sequences of the test code and the first_filtered_codes to generate second_filtered_codes. That is, the second filtering means a task of concatenating all the new lines existing in the character strings, removing all the white spaces existing before and after the character strings and the new lines between the character strings, and then filtering out only the intersection values. For example, by using set( ) function in python, after DATA1=set( ), by performing DATA1.intersection(DATA2), only data that is an intersection from the two DATA1 and DATA2 may be returned, and the returned data may be removed.

### 3) Exhaustive Search

Most of the data is removed during the second filtering process. However, a method is required to completely eliminate duplication. In third filtering of Algorithm 1, an exhaustive search may be performed to mutually compare s and TEST_codes to remove a few remaining duplicate data traces, and finally generate third_filtered_codes to be used as the training data. That is, in the third filtering, the duplicate data may be removed by comparing all words based on the white spaces.

### Forming Positive & Negative Pairs

The model requires two types of training data to train the code similarity determination model. One type of training data is positive pairs, which may determine whether the two codes are similar, and the other is negative pairs, which may determine whether the two codes are not similar. The positive pairs may mean code pairs that are capable of solving the same problem (label 0), and a sum of token lengths of the two codes may be sliced such that the sum is no more than 512, which is the maximum size that can be fed into the model. The negative pairs may generate code pairs that do not solve the same problem (label 1), using the BM25 algorithm.

For negative samples, ranks are assigned after sorting the data in descending order based on a (confidence) score. Therefore, the present invention proposes a method of generating positive and negative pairs using BM25 algorithm of the Okapi system, which has already been proven in document retrieval methods, and/or BM25L algorithm, which is a variant thereof, to develop an efficient similarity evaluation model. Based on this, the efficiency of the similarity evaluation model between codes may be enhanced.

The BM25 may calculate scores for document D with respect to query sentence Q including keywords k₁, . . . , kₙ (where n is an arbitrary natural number) as the following mathematical expression.

$$score ( D , Q ) = {\sum }_{i = 1}^{n} I D F ( {k}_{i} ) \cdot \frac{f ( {k}_{i} , D ) \cdot ( {m}_{1} + 1 )}{f ( {k}_{i} , D ) + {m}_{1} \cdot ( b \cdot \frac{\vert D \vert}{a d l} + 1 - b )}$$

In the mathematical expression above, f(k₁,D) is term frequency (TF) of k₁ in D, |D| is length of words, and adl is average document length. m₁ and b are hyperparameters.

$$I D F ( {k}_{i} ) = ln ( \frac{N - n ( {k}_{i} ) + 0.5}{n ( {k}_{i} ) + 0.5} ) + 1$$

The inverse document frequency (IDF) indicates how rare a word is in the total document set. IDF(kᵢ) consists of IDF weight of query term kᵢ, and n(kᵢ) indicates the number of documents including kᵢ. Using the algorithm described above, the volume of the original dataset may dramatically expand.

### Cross-Validation Ensemble

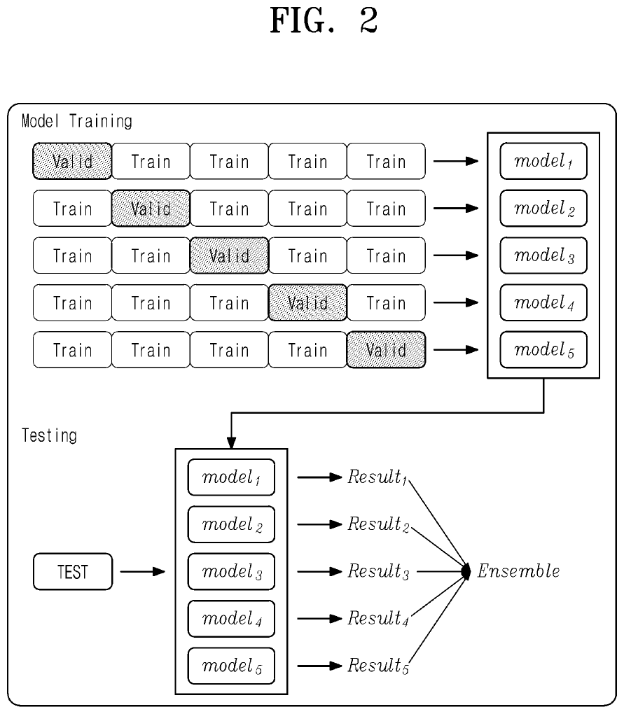

Since the training process of the model is divided into training dataset, validating dataset, and testing dataset, each of which is independent of the other, an accurate performance evaluation may not be performed when there is an imbalance in the data. FIG. 2 illustrates an overall schematic view of a cross-validation ensemble technique. In FIG. 2, K-fold cross-validation (K is an arbitrary natural number greater than or equal to 2, with an exemplary value of 5) may train K models on each dataset K times in the model training step, thus performing a more accurate performance evaluation. In the present invention, a technique of evaluating final performance is used by recording a point indicating the best performance for each fold and creating an ensemble of the determinations made by the K models generated in the testing step.

For example, the odd number of results for each fold may be extracted from the trained model results. With a five-fold for each model, 15 results may be extracted from three models. When the cross-validation ensemble technique is used, a result value of a sum of all predicted values divided by the number of folds is compared to a threshold value to derive a final result. Specifically, with the threshold value of 0.5, when an average of all the predicted values is greater than 0.5, the result is predicted to be 1, otherwise 0.

By using all data in the training process, the model is not simply trained on one piece of data, but may perform more effectively with the determination of the model trained from a different perspective.

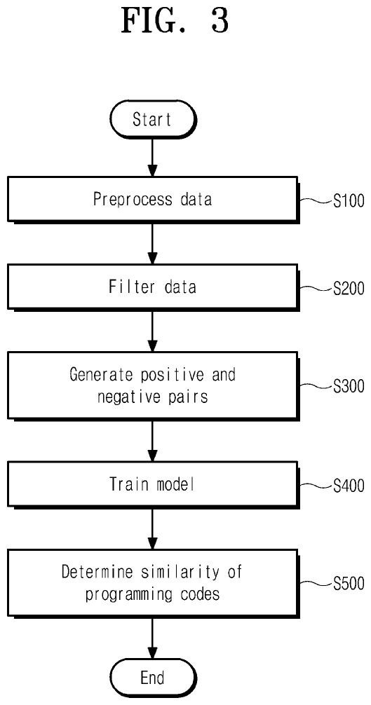

FIG. 3 is a flowchart for describing a method of generating a similarity determination model or a method of determining similarity, according to an embodiment of the present invention. At least a part of each of the steps illustrated in FIG. 3 may be performed by a computing system. In addition, the computing system may be referred to as a device for generating a similarity determination model, a similarity determination device, or the like.

First, a preprocessing operation is performed on the data (S100). Specifically, the preprocessing operation described above may be performed on raw data consisting of a plurality of programming codes. However, depending on embodiments, step S100 may be omitted.

Next, a filtering operation may be performed on the data (S200). That is, by filtering out duplicate content within the programming code, it is possible to avoid problems of being trained using duplicate data. The filtering operation may be configured in three steps, which will not be described in detail.

Using the filtered data, negative and positive pairs may be generated for use in training the model (S300). The positive and negative pairs may be generated using algorithms such as BM25 and/or BM25L.

A model for determining a similarity of the programming codes may be generated by training and fine-tuning a predetermined model using the generated negative and positive pairs (S400). In the present invention, graphcodebert and codebert-mlm are used as a pre-trained model, but the present invention is not limited thereto. That is, any pre-trained model may be used.

In addition, the training may be progressed using the cross-validation ensemble model. K times of training may be performed by varying training and validation sets. For example, the generated training data may be divided into K pieces based on an arbitrary criterion, and the K pieces of data are used to train K models, while ensuring that the validation set of each model does not overlap. To this end, all data may be used for training.

Lastly, the similarity of two programming codes being input may be determined (S500). The similarity is performed using the similarity determination model that has been trained.

The aforementioned method according to example embodiments may be implemented in a form of a program executable by a computer apparatus. Here, the program may include, alone or in combination, a program instruction, a data file, and a data structure. The program may be specially designed to implement the aforementioned method or may be implemented using various types of functions or definitions known to those skilled in the computer software art and thereby available. Also, here, the computer apparatus may be implemented by including a processor or a memory that enables a function of the program and, if necessary, may further include a communication apparatus.

The program for implementing the aforementioned method may be recorded in computer-readable record media. The media may include, for example, a semiconductor storage device such as an SSD, ROM, RAM, and a flash memory, magnetic disk storage media such as a hard disk and a floppy disk, optical record media such as disc storage media, a CD, and a DVD, magneto optical record media such as a floptical disk, and at least one type of physical device capable of storing a specific program executed according to a call of a computer such as a magnetic tape.

Although some example embodiments of an apparatus and method are described, the apparatus and method are not limited to the aforementioned example embodiments. Various apparatuses or methods implementable in such a manner that one of ordinary skill in the art makes modifications and alterations based on the aforementioned example embodiments may be an example of the aforementioned apparatus and method. For example, although the aforementioned techniques are performed in order different from that of the described methods and/or components such as the described system, architecture, device, or circuit may be connected or combined to be different form the above-described methods, or may be replaced or supplemented by other components or their equivalents, it still may be an example embodiment of the apparatus and method.

The device described above can be implemented as hardware elements, software elements, and/or a combination of hardware elements and software elements. For example, the device and elements described with reference to the embodiments above can be implemented by using one or more general-purpose computer or designated computer, examples of which include a processor, a controller, an ALU (arithmetic logic unit), a digital signal processor, a microcomputer, an FPGA (field programmable gate array), a PLU (programmable logic unit), a microprocessor, and any other device capable of executing and responding to instructions. A processing device can be used to execute an operating system (OS) and one or more software applications that operate on the said operating system. Also, the processing device can access, store, manipulate, process, and generate data in response to the execution of software. Although there are instances in which the description refers to a single processing device for the sake of easier understanding, it should be obvious to the person having ordinary skill in the relevant field of art that the processing device can include a multiple number of processing elements and/or multiple types of processing elements. In certain examples, a processing device can include a multiple number of processors or a single processor and a controller. Other processing configurations are also possible, such as parallel processors and the like.

The software can include a computer program, code, instructions, or a combination of one or more of the above and can configure a processing device or instruct a processing device in an independent or collective manner. The software and/or data can be tangibly embodied permanently or temporarily as a certain type of machine, component, physical equipment, virtual equipment, computer storage medium or device, or a transmitted signal wave, to be interpreted by a processing device or to provide instructions or data to a processing device. The software can be distributed over a computer system that is connected via a network, to be stored or executed in a distributed manner. The software and data can be stored in one or more computer-readable recorded medium.

A method according to an embodiment of the invention can be implemented in the form of program instructions that may be performed using various computer means and can be recorded in a computer-readable medium. Such a computer-readable medium can include program instructions, data files, data structures, etc., alone or in combination. The program instructions recorded on the medium can be designed and configured specifically for the present invention or can be a type of medium known to and used by the skilled person in the field of computer software. Examples of a computer-readable medium may include magnetic media such as hard disks, floppy disks, magnetic tapes, etc., optical media such as CD-ROM's, DVD's, etc., magneto-optical media such as floptical disks, etc., and hardware devices such as ROM, RAM, flash memory, etc., specially designed to store and execute program instructions. Examples of the program instructions may include not only machine language codes produced by a compiler but also high-level language codes that can be executed by a computer through the use of an interpreter, etc. The hardware mentioned above can be made to operate as one or more software modules that perform the actions of the embodiments of the invention and vice versa.

While the present invention is described above referencing a limited number of embodiments and drawings, those having ordinary skill in the relevant field of art would understand that various modifications and alterations can be derived from the descriptions set forth above. For example, similarly adequate results can be achieved even if the techniques described above are performed in an order different from that disclosed, and/or if the elements of the system, structure, device, circuit, etc., are coupled or combined in a form different from that disclosed or are replaced or substituted by other elements or equivalents. Therefore, various other implementations, various other embodiments, and equivalents of the invention disclosed in the claims are encompassed by the scope of claims set forth below.

What is claimed is:

1. A method of generating a similarity determination model of programming codes performed by a computing device including at least a processor, the method comprising:
performing preprocessing on raw data written in any one language;
performing filtering on the preprocessed data;
generating positive pairs and negative pairs for training; and
training a pre-trained language model using the generated positive pairs and negative pairs.

2. The method of claim 1, wherein in the performing of the preprocessing, at least one of removing a new line, removing a space, removing a comment, and removing a null space is performed.

3. The method of claim 1, wherein the performing of the filtering comprises a first filtering step of generating a hash table for first data included in the preprocessed data, and removing duplicate data from the first data and second data included in the preprocessed data using the hash table.

4. The method of claim 3, wherein the performing of the filtering comprises a second filtering step of removing all white spaces existing before and after each line and all new lines between character strings by concatenating all new lines for data first-filtered by the first filtering step, and then removing only intersection values.

5. The method of claim 4, further comprising:
a third filtering step of removing duplicate data through a comparison between all words based on the white space, for data second-filtered by the second filtering step.

6. The method of claim 5, wherein in the generating of the positive and negative pairs, the positive pairs and the negative pairs are generated from the data thirdly filtered by the third filtering step using the BM25 algorithm or the BM25L algorithm.

7. The method of claim 6, wherein in the training of the pre-trained language model, the pre-trained language model is trained using a cross-validation ensemble technique, and
wherein the pre-trained language model is a graphcdebert or a codebert-mlm.
